(19) United States
(12) Patent Application Publication
(10) Pub. No.: US 2015/0152973 A1
(43) Pub. Date: Jun. 4, 2015

(54) PIEZO-ACTUATED PILOT VALVE

(71) Applicant: Parker-Hannifin Corporation, Cleveland, OH (US)

(72) Inventor: Steven Mark Mesner, Tomah, WI (US)

(21) Appl. No.: 14/613,984

(22) Filed: Feb. 4, 2015

Related U.S. Application Data
(63) Continuation-in-part of application No. 13/909,820, filed on Jun. 4, 2013.
(60) Provisional application No. 61/655,055, filed on Jun. 4, 2012.

(51) Int. Cl. F16K 31/124; F16K 1/00

(52) U.S. Cl. CPC F16K 31/1245; F16K 1/00

(57) ABSTRACT

A piezo-actuated pilot valve that takes advantage of the small compact size and low power requirement of piezo technology to control the pilot flow in a pilot-operated valve. Exemplary piezo-actuated valves can be operated using a relatively low voltage power supply, such as a battery or a solar cell. This enables usage of the valve in remote locations that do not have a ready source of utility-supplied electrical power. The piezo-actuated pilot valve also can have a programmable controller and/or can have an antenna that allows the valve to be controlled wirelessly.

### RELATED APPLICATIONS

This application is a continuation-in-part of U.S. patent application Ser. No. 13/909,820 filed Jun. 4, 2013, which claims the benefit of U.S. Provisional Application No. 61/655,055 filed Jun. 4, 2012, all of which are hereby incorporated herein by reference.

### FIELD OF INVENTION

The present invention relates generally to pilot operated valves, and more particularly to a low power pilot operated valve actuated by a piezoelectric actuator that enables use of the valve in locations remote from utility-supplied power.

### BACKGROUND

Pilot-operated valves utilize system pressure to create force imbalances within the valve to open or close the main piston, or poppet, which in turn controls flow through the main port of the valve. Control of the pilot flow typically is done with a solenoid coil for on/off valves, or some type of pressure sensing device such as a spring-loaded diaphragm for pressure regulating control valves.

Both of the conventional methods of controlling pilot operated valves have drawbacks. Solenoid, or on/off valves, utilize coils which consume large amounts of power and are unreliable over millions of cycles. Mechanically-operated pressure regulating valves are slow to respond, and are reactive to system pressure changes.

### SUMMARY OF INVENTION

The present invention provides a piezo-actuated pilot valve that takes advantage of the small compact size and low power requirement of piezo technology to control the pilot flow in a pilot-operated valve. Exemplary piezo-actuated valves can be operated using a relatively low voltage power supply, such as a battery or a solar cell. This enables usage of the valve in remote locations that do not have a ready source of utility-supplied electrical power. The piezo-actuated pilot valve also can have a programmable controller and/or can have an antenna that allows the valve to be controlled wirelessly.

According to one aspect of the invention, a pilot valve includes a first port in selective fluid communication with a second port by a passageway through the valve; a valve seat; a movable piston selectively engagable with the valve seat to close the valve when the valve member engages the valve seat and to open the valve when the valve member is spaced from the valve seat; a pilot passageway providing a pathway to a portion of the piston opposite the side that engages the valve seat, the pathway being opened and closed by a pilot plug; and a piezo unit operable to control movement of the pilot plug to control whether the pathway is opened or closed.

Optionally, the piezo unit is powered by a battery.

Optionally, the battery is a rechargeable battery.

Optionally, the pilot valve includes a solar panel electrically coupled to the battery for recharging the battery.

Optionally, the pilot valve includes a solar panel electrically coupled to the piezo unit for providing power to the piezo unit.

Optionally, the pilot valve includes an antenna for receiving a wireless signal.

Optionally, the valve is wirelessly controlled.

Optionally, the pilot valve includes a controller for controlling the piezo unit.

The foregoing and other features of the invention are hereinafter described in greater detail with reference to the accompanying drawings.

### BRIEF DESCRIPTION OF THE DRAWINGS

FIG. 1 is a cross-sectional view of an exemplary embodiment of a piezo-actuated pilot valve.

FIG. 2 is a cross-sectional view of another exemplary embodiment of a wireless piezo-actuated pilot valve.

FIG. 3 is a cross-sectional view of still another exemplary embodiment of a piezo-actuated pilot valve.

FIG. 4 is an enlargement of a bonnet portion of the valve of claim FIG. 3.

### DETAILED DESCRIPTION

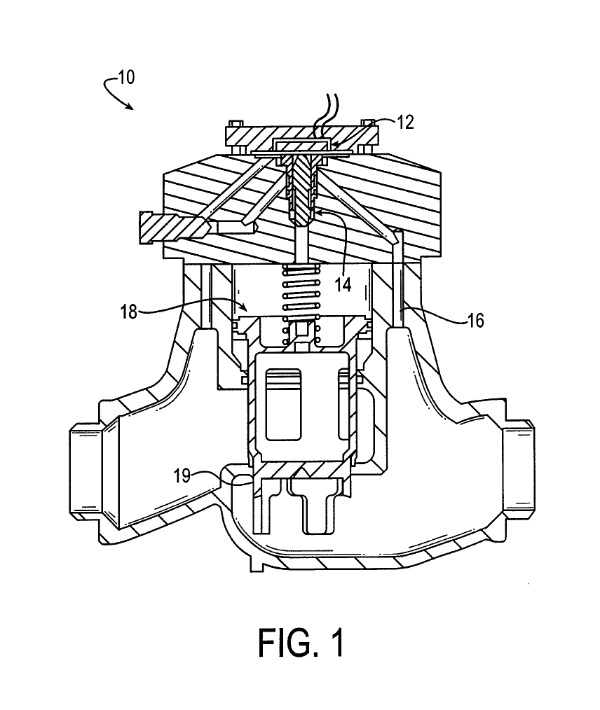

An exemplary embodiment of a piezo-actuated pilot valve 10 is shown in FIG. 1. The pilot valve 10 includes a first port 11 in selective fluid communication with a second port 13 by a passageway through the valve 10. A movable valve member (main piston plug) 18 is selectively engagable with the valve seat 19 to close the valve 10 when the valve member 18 engages the valve seat 19 and to open the valve 10 when the valve member 18 is spaced from the valve seat 19. A pilot passageway 16 provides a pathway to a portion of the valve member 18 opposite the side that engages the valve seat. The pathway is opened and closed by a pilot plug 14.

The valve 10 includes a smart material 12 operable to control movement of the pilot plug to control whether the pathway 16 is opened or closed. The smart material 12 may be, for example, a piezoelectric material. The stack 12 may also be referred to herein as a “wafer” or “piezo unit”. The piezo unit 12 controls movement of a pilot plug/cartridge 14, which can include a small mechanical pilot assembly which in turn controls the pilot flow via pilot passageway 16 to or from the main piston 18 or poppet of the valve. The main piston engages/disengages a valve seat 19 to open/close the valve. Controlling the pilot flow controls the pressure imbalances on the main piston/poppet, forcing it open or closed.

The piezo unit is a highly reliable, precise unit which draws very little power to operate. Power supply to these units is typically 12 or 24 volts with current draws less than one milliamp. The piezo unit can therefore be powered by a low power energy source, such as battery power, solar power, or another energy source. The movement of the piezo stack is proportional to the amount of energy that is supplied. The energy supplied can be full power for maximum movement to be used in on/off applications, or proportional from a controller based on feedback from any type monitoring system producing a 4-20 Ma or 0-10 V signal. Thus, the piezo unit takes the place of large electrical coils, or mechanical pressure sensing devices such as springs.

The piezo unit should, preferably, be isolated or sealed away from the operating fluid, especially in refrigerant applications.

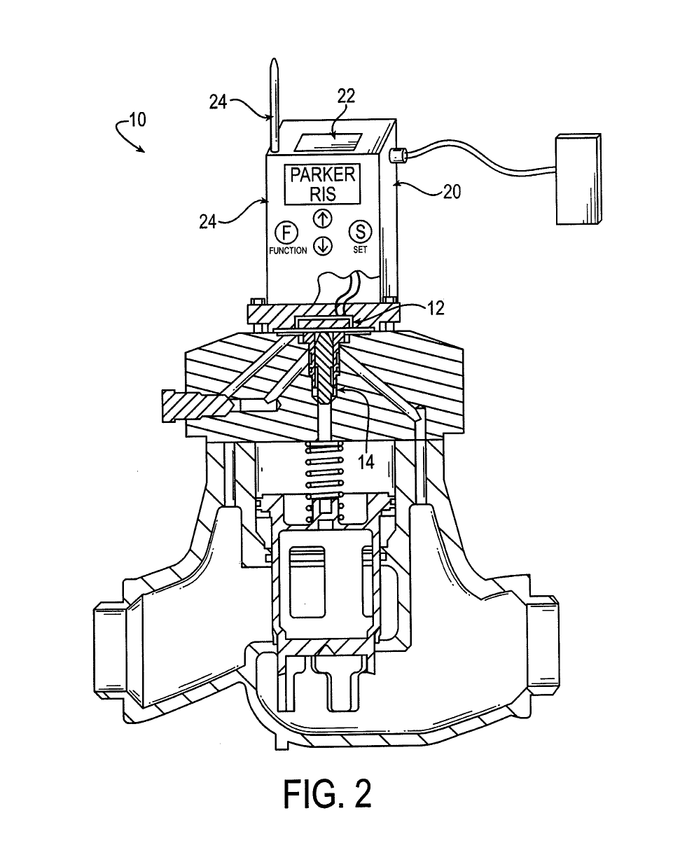

Because of the low power consumption of the piezo unit, it is possible for the unit to be powered by an on-board battery 20 integral to the valve assembly, as shown in FIG. 2.

Because many valves are located outside, the battery can be recharged through a solar panel 22 on the valve. Piezo units also give off electrical charges when they are moved, such as with the vibrations from piping; this may also be a means of collecting energy to keep the battery charged to operate the valve. Coupling this technology with wireless technology to send the valve control signals, the valve can be operated without any wires for power or control.

For example, as shown in FIG. 2, the pilot valve can include an antenna 20 for receiving a wireless signal for controlling the valve. Accordingly, the valve disclosed herein can be a totally wireless powered and actuated control valve, and can lead to energy savings from reduced power consumption to operate solenoid coil operated valves. The valve also may include a programmable controller 24 with, for example, one or more LEDs.

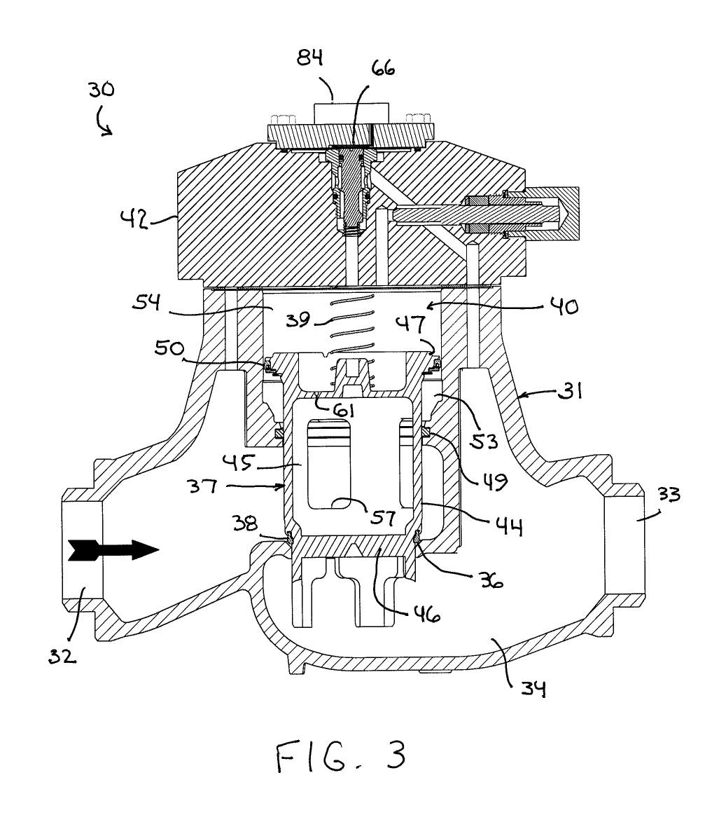

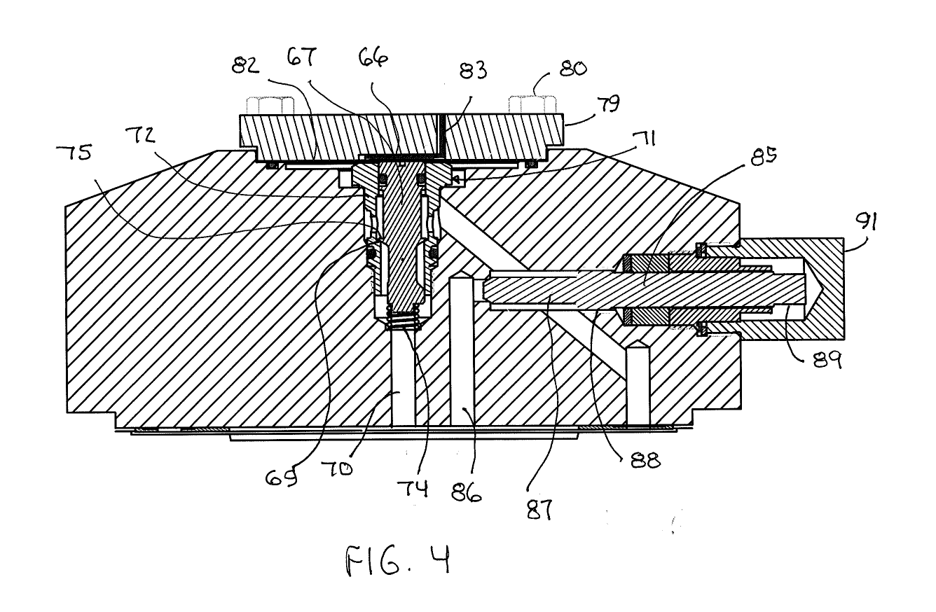

Referring now to FIGS. 3 and 4, another exemplary pilot valve is indicated generally at 30. The pilot valve 30 includes a valve body 31 having an inlet port 32 and an outlet port 33 connected by a passageway 34. The passageway 34 extends through a valve seat 36, the opening of which is open and closed by a main valve member 37 that is mounted in the valve body 31 for movement into and out of engagement with the valve seat. The main valve member may include an annular resilient seal 38 for effecting sealing engagement with the valve seat 36. The main valve member is biased by a spring 39 toward and against the valve seat. The spring 39 is disposed in a piston chamber 40 in the valve body between the main valve member and the underside of a bonnet body 42. The bonnet body may be attached to a lower portion of the valve body 31 by any suitable means, such as bolts (not shown).

In the illustrated embodiment, the main valve member 37, which can also be referred to as a main poppet valve, has a tubular central portion 44 that surrounds an interior chamber 45 closed at its end nearest the valve seat 36 by a valve end wall 46 and at its upper end by a piston head 47. The tubular central portion 44 is guided by a guide sleeve ring 49 that is retained in an annular groove in the valve body 31 and the piston head 47 that is sealed by a suitable seal 50 to the interior wall of the piston chamber 40. The piston head 47 divides the piston chamber 40 into a valve side chamber 53 and a control chamber 54. The valve side chamber 53 is in fluid communication with the inlet port via one or more passages 57 provided in the wall of the tubular central portion 44. Consequently, fluid pressure at the inlet port 32 will act on the side of the piston head 47 nearest the valve seat 36 in a direction wanting to move the main valve member to an open position thereby opening the pilot valve for flow of fluid from the inlet port to the outlet port 33. The piston head preferably has an effective cross-sectional area greater than the effective cross-sectional area of the valve seat opening.

In the illustrated embodiment, the piston head 47 is provided with an orifice 61 allowing metered flow from the valve side chamber 53 to the control chamber 54, although it will be understood the orifice may be located elsewhere such as in passageway in the valve body connecting the control chamber to a location upstream of the valve seat 36. Metered flow will result in a net force (fluid pressure and the force of the spring 39) acting to hold the main valve member closed against the valve seat for blocking flow through the valve.

The main valve member 37 can be caused to move away from the valve seat 36 by bleeding off fluid pressure from the control chamber 54. This is accomplished by a peizo unit 66 that controls movement of a pilot valve member 67. The pilot valve member controllably blocks and permits flow from the control chamber 54 to a location downstream of the valve seat 36 which will be at a lower pressure than the inlet pressure. As described in greater detail below, energization of the piezo unit will cause the pilot valve member to move into and out of engagement with a pilot valve seat 69 surrounding a passage 70 that connects the control chamber 54 to the downstream side of the main valve seat 36, and more particularly to the passage 34 downstream of the main valve seat 36. That is, bleeding off pressure from the control chamber 54 will allow the pressure in the chamber 53 to push the poppet upwards opening the main valve. Conversely, stopping pressure from being bled off from the control chamber 54 will allow the pressure to build up in the control chamber again causing the poppet to move to its closed position.

Alternate closing and opening of the pilot valve member (poppet) 67 can be time-modulated to create a pilot valve duty cycle that is something less than full-time open (or full closed), the duty cycle determining how much the pressure is reduced in the control chamber 54. The reduced pressure in the control chamber will cause the main control valve 37 to open by a proportionate amount.

In the illustrated embodiment, the piezo unit 66 and pilot valve member may be conveniently provided on or in the bonnet body 42. The pilot valve member 67 and associated pilot valve seat 69 are preferably provided as part of a cartridge valve assembly 71 including a pilot valve sleeve 72 that is threaded into a bore in the bonnet body. The pilot valve member 67 is axially movable in the sleeve 72 and normally is biased by a pilot valve spring 74 toward an open position. The pilot valve member may have a radially outwardly protruding annular sealing portion 75 that engages and seals against the pilot valve seat 69 formed by a shoulder on pilot valve sleeve 72. When engaged with the pilot valve seat, the pilot valve member blocks flow through the passage 74 that connects the control chamber with the main valve passage 34 downstream of the main valve seat 36, and thus with the outlet port 33.

The peizo unit 66 includes a smart material operable to control movement of the pilot valve member 67 (pilot plug or pilot valve). The smart material may be, for example, a piezoelectric material such as a piezoelectric wafer or stack. The piezoelectric material is operatively engaged with the pilot valve member. In the illustrated embodiment, the piezoelectric material engages an axial end of the pilot valve member opposite the pilot valve spring 74 which holds the axial end of the pilot valve member against the piezoelectric material. The piezoelectric material preferably is located in a cover member 79 attached to bonnet body 42 by suitable means, such as by the fasteners 80. A metal diaphragm 82 preferably is sandwiched between the piezoelectric material and pilot valve member, as well as between the cover and bonnet body, to fluidically isolate the piezoelectric material from fluid in the bonnet body. The piezoelectric material has electrical leads 83 associated therewith for connection to a controller 84, which may be assembled with or attached to the cover, or located remotely if desired. The controller senses, by means of a suitable sensor(s), the pressure being controlled and causes the peizo unit to open and close the pilot valve member very quickly to control the pressure in the control chamber 40 which ultimately controls the position of the poppet 37. The controller may employ a basic proportional-integral-derivative (PID) loop to control the piezo position and valve poppet position. As seen in FIGS. 3 and 4, the valve 30 may be provided with a manual bypass feature. The manual bypass feature includes a manually operated valve member 85 that opens and closes a bypass passage 86 connecting the control chamber 54 to the passage 74 that connects to the passage downstream of the main valve seat (although it will be appreciated that the passage 86 may independently connect to the passage 74 downstream of the main valve seat 36). The manual valve member 85 may a valve portion 87 that engages a valve seat 87 to close the bypass passage 87 and a threaded stem portion 88 threaded into the bonnet body 42. The outer end of the valve member may protrude outwardly from the bonnet body and be provided with wrenching surfaces 89 so that a wrench can be engaged with the valve stem portion 88 to rotate the valve member for opening and closing the bypass passage. The valve stem can be sealed by suitable means to the bonnet body and the outwardly protruding portion of the valve stem may be covered by a cap 91 or the like.

As above mentioned, the piezo unit 66 is a highly reliable, precise unit that draws very little power to operate. Power supplied to suitable units is typically 12 or 24 volts with current draws less than one milliamp. The piezo unit, as well as the controller, can therefore be powered by a low power energy source, such as battery power, solar power, or another energy source, as in the same manner as described above in connection with the FIGS. 1 and 2 embodiments. The movement of the piezo stack is proportional to the amount of energy that is supplied. Usually the current supplied to the peizo unit is controlled by the controller. The energy supplied can be full power for maximum movement to be used in on/off applications, or proportional from a controller. The controller will usually use feedback from any type monitoring system, which may monitor pressures and/or flow, particularly downstream of the main valve seat

Because of the low power consumption of the piezo unit, it is possible for the unit to be powered by an on-board battery and the battery can be recharged through a solar panel 22 on the valve. This makes the valve particularly suitable for use at locations where utility supplied power is not readily available.

Piezo units also give off electrical charges when they are moved, such as with the vibrations from piping; this may also be a means of collecting energy to keep the battery charged to operate the valve. Coupling this technology with wireless technology to send the valve control signals, the valve can be operated without any wires for power or control.

Like in the embodiment of FIGS. 1 and 2, the pilot valve of FIGS. 3 and 4 can include an antenna for receiving a wireless signal for controlling the valve. Accordingly, the valve disclosed herein can be a totally wireless powered and actuated control valve, and can lead to energy savings from reduced power consumption to operate solenoid coil operated valves.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A pilot-controlled valve comprising:
a valve body having an inlet, an outlet, and a main passageway connecting the inlet to the outlet;
a main valve seat surrounding the main passageway;
a main valve member movable within the valve body between a closed position engaging the valve seat to block flow through the main passageway and an open position permitting flow through the valve seat, the main valve member having a piston that is exposed to pressure in a control chamber in the valve body;
a pilot valve for opening and closing a pathway between the control chamber and the outlet, the pilot valve including a pilot valve seat surrounding the pathway and a pilot valve member movable between closed and open positions respectively blocking and permitting flow through the pathway; and
a piezo unit operable to effect movement of the pilot valve member for opening and closing the pathway to control pressure imbalances acting on the main valve member for moving the main valve member between closed and opened positions.

2. The pilot-controlled valve of claim 1, wherein the piezo unit is powered by a battery.

3. The pilot-controlled valve of claim 2, wherein the battery is a rechargeable battery.

4. The pilot-controlled valve of claim 3, further comprising a solar panel electrically coupled to the battery for recharging the battery.

5. The pilot-controlled valve of claim 1, further comprising a solar panel electrically coupled to the piezo unit for providing power to the piezo unit.

6. The pilot-controlled valve of claim 1, further comprising an antenna for receiving a wireless signal.

7. The pilot-controlled valve of claim 1, further comprising a controller for controlling the piezo unit.

8. The pilot-controlled valve of claim 7, wherein the piezo unit is housed in a cap plate attached to an external surface of the valve body, and the controller is attached to and carried by the cap plate.

9. The pilot-controlled valve of claim 8, wherein the pilot valve is formed in a cartridge installed in a bore in the valve body that opens to the external surface, and the bore is closed by the cap plate.

10. The pilot-controlled valve of claim 9, including a diaphragm disposed between piezo unit and the cartridge that isolates the piezo unit from fluid in the bore.

11. The pilot-controlled valve of claim 10, wherein the cartridge includes an outer body including a valve seat and the pilot valve member is guided with the valve seat for movement into and out of engagement with the valve seat.

12. The pilot-controlled valve of claim 1, including a spring disposed to bias the poppet toward its closed position.

13. The pilot-controlled valve of claim 1, including a spring disposed to bias the pilot valve member toward its closed position.

14. The pilot-controlled valve of claim 1, further comprising a bypass passage between the control chamber and the outlet port, and a plug having a proximal end for closing the bypass passage and a distal end accessible from outside the valve body for allowing manual movement of the plug from a closed position blocking flow between the control chamber and the outlet port to an open position permitting flow from the control chamber to the outlet port independently of the pilot valve.

15. The pilot-controlled valve of claim 1, including a bleed orifice connecting the inlet port to the control chamber.

16. The pilot-controlled valve of claim 15, wherein the bleed orifice is located in the poppet.

17. A self-powered pilot-controlled valve assembly for use in remote locations, comprising:
a valve body having an inlet, an outlet, and a main passageway connecting the inlet to the outlet;
a main valve seat surrounding the main passageway;
a main valve member movable within the valve body between a closed position engaging the valve seat to block flow through the main passageway and an open position permitting flow through the valve seat, the main valve member having a piston that is exposed to pressure in a control chamber in the valve body;
a pilot valve member for opening and closing a pathway between the control chamber and the outlet;
a piezo unit operable to effect movement of the pilot valve member for opening and closing the pathway to control pressure imbalances acting on the main valve member for moving the main valve member between closed and opened positions; and
an electrical storage for supplying power to the piezo unit.

18. The assembly of claim 17, further comprising a controller for controlling the piezo unit.

19. The assembly of claim 18, further comprising an antenna for receiving a wireless signal.

20. The assembly of claim 17, further comprising a solar panel electrically coupled to the electrical storage for recharging the electrical storage.
